(19) United States
(12) Patent Application Publication
(10) Pub. No.: US 2025/0384412 A1
(43) Pub. Date: Dec. 18, 2025

(54) Audit_Resilient BEI _24HWS Global Sovereign Ecosystem

(71) Applicant: FURONG BEI, SAN GABRIEL, CA (US)

(72) Inventor: FURONG BEI, SAN GABRIEL, CA (US)

(21) Appl. No.: 19/192,322

(22) Filed: Apr. 28, 2025

(51) Int. Cl. G06Q 20/06; G06Q 20/38; G06Q 20/40; G06Q 40/04

(52) U.S. Cl. CPC G06Q 20/0658; G06Q 20/3821; G06Q 20/4014; G06Q 40/046; G06Q 40/055; G06Q 2220/00

(57) ABSTRACT

A fully decentralized, audit-resilient sovereign ecosystem (“BEI×24HWS”) empowering every individual, household, industry, and region to truly own, govern, mint and inherit their time, identity, and digital resources—without reliance on traditional DNS registrars, centralized identity providers, or recurring renewal fees. The system is built upon three Sovereignty Pillars (Time, Identity, Resource) and seventeen modular components, and includes a turnkey “Domain-to-Module” mapping of all registered top-level and second-level names to demonstrate immediate, fee-free deployment across 365 industries and 82 billion global nodes.

### 1. TECHNICAL FIELD

This invention relates to blockchain networks, decentralized identity frameworks, token-based economies, domain-name banking, smart-contract governance, and vault-based inheritance structures. It introduces an integrated sovereign ecosystem that cryptographically ties human behavior, time usage, identity credentials, and digital assets into an extensible, self-evolving network.

### 2. BACKGROUND ART

1. Registrar Dependency & Renewal Fees. Current DNS registries require annual or bulk renewal fees, limiting true ownership of namespace.
2. Platform-Bound Identities. Phone numbers, passports, or third-party OAuth identities are centrally controlled and can be revoked or audited.
3. Uncaptured Human Behavior Value. Clicks, movements, communications and IoT telemetry generate value today monopolized by intermediaries.
4. Lack of Seamless Inheritance. Digital identities and assets often expire or require manual transfer, hindering multi-generational continuity.

A unified, self-sustaining solution is needed to deliver perpetual, transferable sovereignty over one's time, identity, and resources.

### 3. DISCLOSURE OF THE INVENTION

### 3.1 Objectives

Eliminate third-party registrar renewal costs via on-chain subdomain issuance and automated inheritance.
Provide numberless peer-to-peer sovereign identity with privacy-preserving authentication.
Convert user behavior directly into a native “time currency” (TimeCoin).
Enable domain-as-bank constructs for private minting, governance, and inheritance.
Secure multi-generational vaults with quantum-resistant encryption.
Scale to billions of nodes with zero-hardware energy compute models.

### 3.2 Summary of Technical Solution

The BEI×24HWS ecosystem comprises three core Sovereignty Pillars supported by seventeen modular components:

### A. Time Sovereignty (6 Modules)

1. Behavior & Life-Data Timestamping
2. TimeCoin Generation Engine
3. Subdomain Time-Delay Inheritance
4. Time-Resource Hedging
5. TimeChain Audit Ledger
6. Zero-Energy Soft-Core Compute

### B. Identity Sovereignty (5 Modules)

7. ReadName Identity Protocol
8. Multi-Factor Sovereign Authentication
9. Sovereign Identity Wallet
10. ReadVault Secure Inheritance Vault
11. ZKP Identity Verification

### C. Resource Sovereignty (6 Modules)

12. Domain Bank Architecture
13. ResourceToken Minting Logic
14. DAO Governance Module
15. Behavioral-Economics Integration
16. Domain Token NFT
17. Cross-Domain Interoperability Gateway

Together, these deliver:
No-fee sovereign domains via on-chain allocation and automated renewal.
Number less decentralization of identity, immune to central revocation.
Behavior-to-currency minting, rewarding user actions with TimeCoins.
Domain-banking enables private “banks” and “shops” with custom mint rules.
Quantum-resistant vaults for identity and asset inheritance.
Self-evolving governance with zero-energy compute scaling.

### 4. DETAILED DESCRIPTION

### 4.1 System Architecture

Edge Nodes: Individuals, devices, IoT sensors collect behavior and life-data.
Sovereignty Layer: TimeChain, ReadName, Sovereign Engine smart contracts.
Resource Layer: Domain Bank NFT registry & ResourceToken contracts.
Governance Layer: DAO frameworks, ZKP attestations.
Vault Layer: ReadVault multi-generational encrypted ledgers.

### 4.2 Module Specifications

### Module 1: Behavior & Life-Data Timestamping

Automatically on-chain logs all user events clicks, movements, biometric & IoT feeds-producing a stitched global action ledger.

### Module 2: TimeCoin Generation Engine

Behavioral timestamps feed a minting function, issuing TimeCoins that reflect user engagement and can be staked or exchanged.

### Module 3: Subdomain Time-Delay Inheritance

Hierarchical subdomains auto-renew via smart contract-triggered time lock, ensuring continuity without registrar fees.

### Module 4: Time-Resource Hedging

Mapping temporal behaviors (peak electricity usage, call durations, travel segments) to token issuance, at zero hardware energy cost.

### Module 5: TimeChain Audit Ledger

Immutable, transparent chain storing all behavior/time entries, enabling global audit and compliance tracking.

### Module 6: Zero-Energy Soft-Core Compute

Leverages pure logic-based (“soft-core”) behavior computation, scaling to billions of nodes without physical power draw.

### Module 7: ReadName Identity Protocol

A peer-to-peer, numberless identity network where each user controls their own keys-no phone numbers or central IDs needed.

### Module 8: Multi-Factor Sovereign Authentication

Combines biometric factors and zero-knowledge proofs for on-chain identity verification while preserving privacy.

### Module 9: Sovereign Identity Wallet

Local encrypted wallet storing identity credentials, allowing full user control over data and permissions.

### Module 10: ReadVault Secure Inheritance Vault

Quantum-resistant multi-generational vault enabling automated inheritance of identity and digital assets.

### Module 11: ZKP Identity Verification

Zero-knowledge proof circuits verifying identity claims without exposing raw personal data.

### Module 12: Domain Bank Architecture

Treats each subdomain as a private “bank” or “shop.” configurable with mint rules, inheritance policies, and governance settings.

### Module 13: ResourceToken Minting Logic

Defines formulae mapping behaviors to resource tokens, supporting flexible economic parameters.

### Module 14: DAO Governance Module

Implements multi-tier autonomous governance via on-chain proposals and voting, ensuring self-evolving protocol updates.

### Module 15: Behavioral-Economics Integration

Integrates psychological and economic research into token incentives, forming closed-loop feedback to boost engagement.

### Module 16: Domain Token NFT

Mints each second-/third-level subdomain as an NFT, representing unique ownership and inheritance rights.

### Module 17: Cross-Domain Interoperability Gateway

Enables seamless token & data exchange across industries, national networks, and blockchain platforms.

### 5. IMPLEMENTATION EXAMPLE 1: DOMAIN-TO-MODULE MAPPING

A demonstration table of all registered domains and their assigned modules, illustrating turnkey deployment:

| Domain | Assigned Pillar & Module | Purpose/Notes |
|---|---|---|
| 24readname.com | Identity - ReadName Protocol | 24-hour identity snapshot gateway |
| | (Module 7) | |
| readname.org | Identity - ReadName Community | Standards body & developer portal |
| | (Module 7/11) | |
| readnames.com | Identity - ReadName Management | User identity console |
| | (Module 7) | |
| readingname.com | Identity - ReadName Visualization | Audit log & data visualization |
| | (Module 1) | |
| sreadname.com | Identity - ReadName Sandbox | Sidechain/demo environment |
| | (Module 7) | |
| beiread.com | Identity - ReadName Branded | BEI-branded documentation portal |
| | (Module 7) | |
| beuread.com | Identity - ReadName Mirror | Regional backup |
| | (Module 7) | |
| beureadname.com | Identity - ReadName Trademark | Brand protection redirect |
| | (Module 7) | |
| readnft.com | Resource - Domain Token NFT | NFT minting entry point |
| | (Module 16) | |
| readnfts.com | Resource - Domain Token NFT | Multi-collection NFT marketplace |
| | Market (Module 16) | |
| readcourt.com | Resource - ReadVault/Governance | Legal compliance & arbitration |
| | (Modules 10, 14) | hub |
| readcourt.org | Resource - ReadVault/Governance | Nonprofit legal-standards portal |
| | (Modules 10, 14) | |
| readbrand.com | Resource - Domain Bank (Module | Brand-as-bank services |
| | 12) | |
| govread.com | Identity + Vault (Modules 7, 10) | Government/military secure |
| | | channel |
| rdnames.com | Identity - ReadName Lite (Module | Internal test & minimal branding |
| | 7) | |
| vaultread.com | Resource - ReadVault (Module 10) | Sovereign vault portal |
| readvault.us | Resource - ReadVault US (Module | US-market vault service |
| | 10) | |
| readvault.org | Resource - ReadVault Community | NGO/charity vault option |
| | (Module 10) | |
| readvaults.com | Resource - ReadVault Nodes | Multi-node vault aggregator |
| | (Module 10) | |
| identitysovereignty.com | Identity - ReadName Protocol | Sovereign identity flagship portal |
| | (Module 7) | |
| identitysov.com | Identity - ReadName Protocol | “Identity SOV” tiny portal & SDK |
| | (Module 7) | downloads |
| identitysovereignty.org | Identity - ReadName Community | Community & standards site |
| | (Module 7/11) | |
| identsov.com | Identity - Sovereign Identity Wallet | “ID EnSOV” wallet demo |
| | (Module 9) | |
| idsovereignty.com | Identity - ReadName + ZKP | Backup identity site with ZKP |
| | Verification (Modules 7, 11) | demos |
| idsovereignty.org | Identity - ReadVault Vault (Module | Nonprofit inheritance vault |
| | 10) | |
| resourcesov.com | Resource - ResourceToken Logic | Resource token minting demo |
| | (Module 13) | |
| resourcesov.org | Resource - DAO Governance | Governance portal & proposal hub |
| | (Module 14) | |
| timesov.com | Time - TimeChain Audit Ledger | Sovereign time portal |
| | (Module 5) | |
| timesovereignindex.com | Time - TimeChain Audit Dashboard | Time Sovereignty Index |
| | (Module 5) | visualization |

### 6. INDUSTRIAL APPLICABILITY

This architecture can be deployed immediately by:
Financial Institutions using Domain Bank for sovereign lending/borrowing.
Telecom Providers adopting ReadName for numberless secure comms.
Energy Grids leveraging TimeCoin for peak/off-peak billing.
Healthcare utilizing ReadVault for patient behavior/study inheritance.
IoT Networks embedding Zero-Energy Compute for edge AI incentives.
Education Platforms tokenizing learning behavior with TimeCoins.
Governments integrating DAOs for civic proposals and audits.

1. A global sovereign ecosystem, comprising:
a. a Time Sovereignty pillar, configured to tokenize user behavior and time into a time-based currency and to support on-chain audit and inheritance;
b. an Identity Sovereignty pillar, configured to provide numberless, peer-to-peer identity authentication and multi-generational identity inheritance; and
c. a Resource Sovereignty pillar, configured to treat domain names as private banking and minting constructs with autonomous governance.

2. The ecosystem of claim 1, wherein the Time Sovereignty pillar comprises a Behavior & Life Data Timestamping module that automatically records user time, behavior, life-scene and IoT/wearable telemetry on a global action ledger.

3. The ecosystem of claim 1, wherein the Time Sovereignty pillar comprises a TimeCoin Generation Engine module that mints decentralized time-currency tokens in response to on-chain behavioral timestamps.

4. The ecosystem of claim 1, wherein the Time Sovereignty pillar comprises a Subdomain Time-Delay Inheritance module that automatically renews and locks subdomain ownership via smart-contract time locks.

5. The ecosystem of claim 1, wherein the Time Sovereignty pillar comprises a Time-Resource Hedging module that maps temporal resource usage—such as electricity, call durations or travel segments—to token issuance without hardware energy consumption.

6. The ecosystem of claim 1, wherein the Time Sovereignty pillar comprises a TimeChain Audit Ledger module that provides an immutable, transparent on-chain record of all behavior and time entries for global audit purposes.

7. The ecosystem of claim 1, wherein the Time Sovereignty pillar comprises a Zero-Energy Soft-Core Compute module that enables behavior-driven computation at scale without physical hardware energy draw.

8. The ecosystem of claim 1, wherein the Identity Sovereignty pillar comprises a ReadName Identity Protocol module that offers numberless, peer-to-peer decentralized identity networking without reliance on phone numbers or passports.

9. The ecosystem of claim 1, wherein the Identity Sovereignty pillar comprises a Multi-Factor Sovereign Authentication module combining biometric factors and zero-knowledge proofs for privacy-preserving on-chain identity verification.

10. The ecosystem of claim 1, wherein the Identity Sovereignty pillar comprises a Sovereign Identity Wallet module for local encrypted storage and user-controlled management of identity credentials.

11. The ecosystem of claim 1, wherein the Identity Sovereignty pillar comprises a ReadVault Secure Inheritance Vault module providing quantum-resistant, multi-generational encrypted vaults for identity and asset inheritance.

12. The ecosystem of claim 1, wherein the Identity Sovereignty pillar comprises a ZKP Identity Verification module that uses zero-knowledge proofs to confirm identity claims without exposing raw personal data.

13. The ecosystem of claim 1, wherein the Resource Sovereignty pillar comprises a Domain Bank Architecture module that treats each domain or subdomain as a configurable private “bank” or “shop” with custom minting and inheritance rules.

14. The ecosystem of claim 1, wherein the Resource Sovereignty pillar comprises a ResourceToken Minting Logic module that defines customizable algorithms mapping user behavior to resource token issuance.

15. The ecosystem of claim 1, wherein the Resource Sovereignty pillar comprises a DAO Governance Module for multi-tier autonomous governance, enabling on-chain proposals, voting and protocol updates.

16. The ecosystem of claim 1, wherein the Resource Sovereignty pillar comprises a Behavioral-Economics Integration module that integrates psychological and economic incentive design into token feedback loops.

17. The ecosystem of claim 1, wherein the Resource Sovereignty pillar comprises a Domain Token NFT module that mints each domain or subdomain as a unique non-fungible token representing ownership and inheritance rights.

18. The ecosystem of claim 1, wherein the Resource Sovereignty pillar comprises a Cross-Domain Interoperability Gateway module that enables seamless exchange of tokens and data across different industries, national networks and blockchain platforms.
